(19) United States
(12) Patent Application Publication
(10) Pub. No.: US 2025/0256574 A1
(43) Pub. Date: Aug. 14, 2025

(54) DISPLAYING INDICATIONS CORRESPONDING TO SETTINGS OF HARDWARE VEHICLE CONTROLS

(71) Applicant: Atieva, Inc., Newark, CA (US)

(72) Inventors: Shivandu Tushar Patel, Oakland, CA (US); Soumya Thandra, San Jose, CA (US); Chunkwok Lee, Campbell, CA (US); Nicholas James Hope, Oakland, CA (US); Luis Gustavo Favoreto, San Jose, CA (US); Colin Sebestyen, San Francisco, CA (US)

(21) Appl. No.: 18/704,805

(22) PCT Filed: Sep. 28, 2022
(86) PCT No.: PCT/US2022/077144

§ 371 Date: Apr. 25, 2024

Related U.S. Application Data
(60) Provisional application No. 63/263,142, filed on Oct. 27, 2021.

(51) Int. Cl. B60K 35/28; B60K 35/10; B60K 35/22; B60K 35/80; G06F 3/04847

(52) U.S. Cl. CPC B60K 35/28; B60K 35/10; B60K 35/22; B60K 35/80; G06F 3/04847; B60K 2360/126; B60K 2360/128; B60K 2360/162; B60K 2360/782

(57) ABSTRACT

A computer-based method comprises: receiving, in a computer system of a vehicle, an input generated by user interaction with any of a plurality of hardware controls in the vehicle, the plurality of hardware controls corresponding to respective vehicle systems; and presenting, in response to the input, a container on a display device of the vehicle, the container configured for displaying indications that correspond to and reflect present settings of each of the plurality of hardware controls.

### CROSS-REFERENCE TO RELATED APPLICATION

This application claims priority to U.S. Provisional Patent Application No. 63/263,142, filed on Oct. 27, 2021, and entitled “DISPLAYING INDICATIONS CORRESPONDING TO SETTINGS OF HARDWARE VEHICLE CONTROLS,” the disclosure of which is incorporated by reference herein in its entirety.

### TECHNICAL FIELD

This document relates to displaying indications corresponding to settings of hardware vehicle controls.

### BACKGROUND

As new models and types of vehicles are developed, they are provided with progressively newer features and functions. One feature that has gained popularity is to have a display device that supports user interaction. However, the usability features may be somewhat unintuitive and as a result the user experience may be negatively impacted.

### SUMMARY

In an aspect, a computer-based method comprises: receiving, in a computer system of a vehicle, an input generated by user interaction with any of a plurality of hardware controls in the vehicle, the plurality of hardware controls corresponding to respective vehicle systems; and presenting, in response to the input, a container on a display device of the vehicle, the container configured for displaying indications that correspond to and reflect present settings of each of the plurality of hardware controls.

Implementations can include any or all of the following features. The vehicle has multiple containers for presentation on the display device, the method further comprising selecting the container from among the multiple containers for presentation, the container selected based on the received input. The container selected from among the multiple containers is a volume control container. The plurality of hardware controls includes multiple hardware volume controls, wherein each of the multiple hardware volume controls is configured for increasing and decreasing volume of audio in the vehicle, and wherein the volume control container is presented in response to the user interaction occurring with any of the multiple hardware volume controls. At least one of the multiple hardware volume controls is a roller control, and wherein at least another one of the multiple hardware volume controls is a toggle control. At least one of the multiple hardware volume controls is positioned on a steering wheel of the vehicle, and wherein at least another one of the multiple hardware volume controls is positioned on an instrument panel of the vehicle. The volume control container is presented in response to user interaction with a hardware volume control, and wherein the hardware volume control is configured for controlling whichever one of multiple sound sources in the vehicle that is presently in focus. The volume control container is presented with a respective icon corresponding to a corresponding one of the multiple sound sources. The volume control container has a different numbers of volume control stops for at least some of the multiple sound sources. The multiple sound sources include at least master audio, navigation audio, and short-range wireless audio. The master audio comprises an overall sound of the vehicle. The navigation audio comprises sound that a navigation component is outputting to a sound mixer of the vehicle. The short-range wireless audio comprises sound that a portable electronic device is outputting to a sound mixer of the vehicle by short-range wireless communication. The indication in the volume control container is a slider reflecting a present volume setting. Volume is muted in the vehicle before the input is received, wherein the input corresponds to an increase volume command, and wherein the volume control container when presented indicates that the volume is unmuted. The container selected from among the multiple containers is a heating, ventilation, and air conditioning (HVAC) control container. The plurality of hardware controls includes multiple hardware HVAC controls, wherein the indications in the HVAC control container include multiple HVAC values corresponding to present settings of the multiple hardware HVAC controls, and wherein the HVAC control container is presented in response to the user interaction occurring with any of the multiple hardware HVAC controls. At least one of the multiple hardware HVAC controls is a toggle control. At least one of the multiple hardware HVAC controls is positioned on an instrument panel of the vehicle. A first control of the multiple hardware HVAC controls is dedicated to a left-side passenger of the vehicle, wherein a second control of the multiple hardware HVAC controls is dedicated to a right-side passenger of the vehicle, and wherein the first and second controls are independent of each other. The computer-based method further comprises highlighting in the HVAC control container one of the multiple HVAC values corresponding to the one of the multiple hardware HVAC controls with which the user interaction occurs. The HVAC control container supports simultaneous user interaction using more than one of the multiple hardware HVAC controls. The computer-based method further comprises highlighting those of the multiple HVAC values corresponding to the more than one of the multiple hardware HVAC controls. While the container selected based on the received input is presented, the method further comprises receiving another input generated by another user interaction with another of the plurality of hardware controls, and in response to the other input, replacing content of the container to correspond to the other of the plurality of hardware controls. The content is replaced without ceasing to present the container. Replacing the content comprises ceasing to present the container, and thereafter again presenting the container to include the replaced content. The display device comprises a touchscreen input control. The touchscreen input control is configured for controlling a setting of at least one of the vehicle systems, and wherein the container is not presented upon controlling the setting of the vehicle system using the touchscreen input control. The computer-based method further comprises ceasing to present the container in response to a gesture detected by the touchscreen input control. The computer system presents content on the display device, and wherein the container is presented on top of at least some of the content. The content includes modal content, and wherein the container is presented below the modal content. Presenting the container comprises presenting an animation wherein the container performs a move out onto the display device from an edge of the display device, and wherein the move takes a predefined time. A signal from the one of the plurality of hardware controls with which the user interaction occurs is active during the move. The computer-based method further comprises ceasing to present the container in response to a predefined time elapsing after a most recent user interaction with any of the plurality of hardware controls.

### BRIEF DESCRIPTION OF DRAWINGS

FIGS. 1A-1D show examples of containers that can be used for displaying indications corresponding to settings of hardware vehicle controls.

FIG. 2 shows an example of an instrument panel of a vehicle.

FIG. 3 shows an example of a system.

FIG. 4 shows examples of hardware controls.

FIG. 5 shows an example of a toggle control.

FIGS. 6A-6C show examples of presentations on a display device relating to an HVAC control container.

FIGS. 7A-7E show examples of presentations on a display device relating to a volume control container.

FIGS. 8A-8B show examples of layering of a container.

FIG. 9 illustrates an example architecture of a computer system.

Like reference symbols in the various drawings indicate like elements.

### DETAILED DESCRIPTION

This document describes examples of systems and techniques for displaying indications corresponding to vehicle control settings. In some implementations, presenting a container with settings of hardware controls can merge the user's experiences of using physical versus virtual controls, and can thereby improve usability and the experience of the vehicle user. An on-screen container can be a digital inverted version of some or all physical controls to further strengthen the intuitiveness of the user interface. The container can promulgate a clean visual appearance of vehicle interactions for passengers. For example, the container is immediately presented when needed, provides logical and helpful visual guidance, and discretely vanishes when no longer used.

Examples described herein refer to a vehicle. As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. In the present disclosure, any occupant of a vehicle is referred to as a passenger, regardless of whether the occupant may exercise any control over the motion of the vehicle (e.g., by steering, accelerating, or braking). For example, in the front seat, a passenger on the left side can be referred to as a left-side passenger, and vice versa. A vehicle can be powered by one or more types of power sources. In some implementations, a vehicle is powered solely by electricity, or can use one or more other energy sources in addition to electricity, to name just a few examples.

Examples herein refer to display devices. A display device visually outputs a graphical user interface for one or more computer devices. A display device can operate according to any of multiple display technologies used for presenting computer-based information. A display device can include a liquid crystal display (LCD), a light-emitting diode (LED) display, and/or a plasma display, to name just a few examples. A display device can be configured for receiving input for the computer device(s). In some implementations, a display device can feature one or more types of technology for detecting contact with, or proximity to, the screen by a user's hand or an implement such as a stylus. A display device can operate according to any of multiple touch-detecting, or gesture-recognizing, technologies. A display device can include a resistive touchscreen, a capacitive touchscreen, and/or a touchscreen based on optical imaging, to name just a few examples. A display device can have any of multiple shapes. In some implementations, a display device has a quadrilateral shape (e.g., rectangular), or a non-polygonal shape, to name just a few examples. A display device can have a substantially flat form factor (e.g., the screen is essentially planar), or a non-flat form factor (e.g., the screen is curved according to one or more radiuses.)

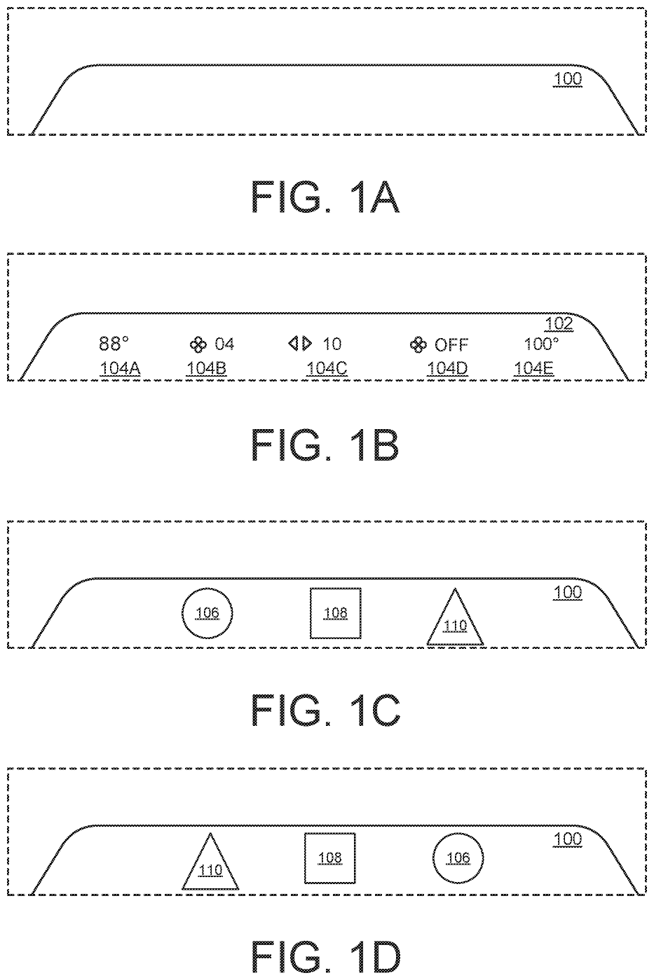

FIGS. 1A-1D show examples of containers 100 and 102 that can be used for displaying indications corresponding to settings of hardware vehicle controls. Each of the containers 100 and 102 is here schematically shown as being included on a respective screen presented by a corresponding display device. The container 100 is shown without any visible indications. One or more of the indications described elsewhere herein can be added to the container 100. In some implementations, the container 100 can seamlessly appear on a display device immediately upon a user interacting with a hardware control in the vehicle. When not needed, the container 100 can disappear to avoid distraction.

The container 102 shows examples of indications 104A-104E. In some implementations, the indications 104A-104B can be dedicated for a left-side passenger in the vehicle. For example, the indication 104A can correspond to a temperature setting, and the indication 104B can correspond to a fan speed setting. In some implementations, the indications 104D-104E can be dedicated for a right-side passenger in the vehicle. For example, the indication 104D can correspond to a fan speed setting, and the indication 104E can correspond to a temperature setting. In some implementations, the indication 104C can correspond to a volume setting. The volume setting can be applied to one or more audio zones in the vehicle. One or more of the indications 104A-104E can be highlighted.

Containers can support parameter placement according to one or more reading directions. FIG. 1C shows an implementation where the container 100 supports a left-to-right (LTR) reading layout. For example, content 106, content 108, and content 110 are placed in order from left to right in the LTR reading layout. FIG. 1D shows an implementation where the container 100 supports a right-to-left (RTL) reading layout. For example, the content 106, the content 108, and the content 110 are placed in order from right to left in the RTL reading layout. The system can be configured with one of the LTR or RTL reading layouts depending on the region where the vehicle is intended to be used. As another example, the system can be controlled to change between the LTR or RTL reading layouts.

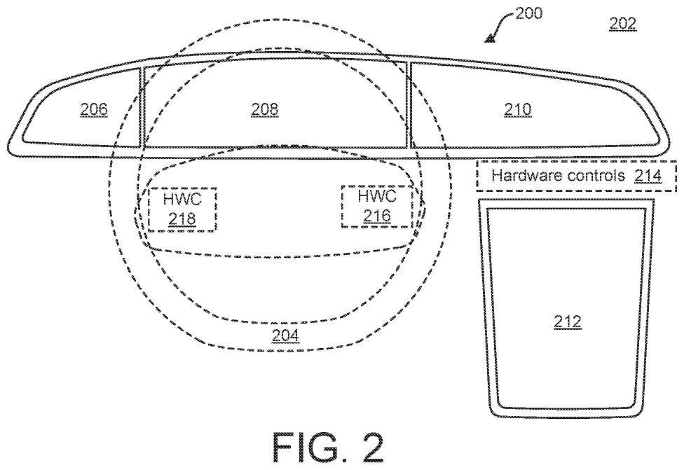

FIG. 2 shows an example of an instrument panel 200 of a vehicle 202. The vehicle 202 is mostly omitted in the present illustrations for simplicity. The vehicle 202 includes a steering wheel 204 (here shown in phantom for clarity), that can be used in connection with, or independently of, one or more controls or functions available at the instrument panel 200. The instrument panel 200 can be used in combination with one or more other examples described elsewhere herein.

The instrument panel 200 includes a display device 206 here positioned somewhat to the left of the steering wheel 204. The instrument panel 200 includes a display device 208 here positioned essentially behind the steering wheel 204. The instrument panel 200 includes a display device 210 here positioned somewhat to the right of the steering wheel 204. The display device 210 can be horizontally aligned with an instrument cluster in the vehicle 202. For example, the instrument cluster can include at least the display device 208. The instrument panel 200 includes a display device 212 here positioned lower than (e.g., essentially vertically below) the display device 210. The display device 212 is considered to be positioned in the instrument panel 200. For example, the display device 212 can be positioned lower in the same physical housing in which the display devices 206, 208, and 210 are mounted. A visual representation shown or mentioned herein can be presented on one or more of the display devices 206, 208, 210, or 212.

The vehicle 202 can have one or more hardware controls. In some implementations, the instrument panel 200 can include one or more buttons, toggles, scroll wheels, or other physical control devices by which the driver can make at least one input. Here, hardware controls 214 on the instrument panel 200 are schematically represented. In some implementations, the steering wheel 204 can include one or more buttons, toggles, scroll wheels, or other physical control devices by which the driver can make at least one input. Here, hardware controls (HWC) 216 and 218 on the steering wheel 204 are schematically represented.

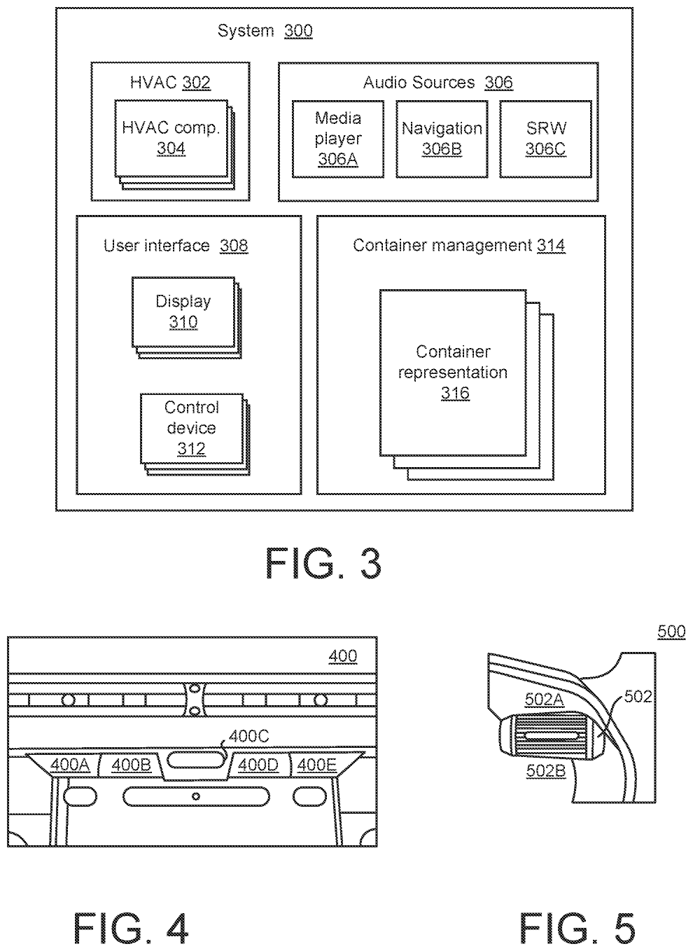

FIG. 3 shows an example of a system 300. The system 300 can be implemented as part of a vehicle and can be used in combination with one or more other examples described elsewhere herein. The system 300 includes a heating, ventilation, and air conditioning (HVAC) system 302. The HVAC system 302 includes one or more HVAC components 304 (e.g., a heater, air conditioner, fan, and/or radiator). One or more of the HVAC components 304 can be controller by a respective hardware control.

The system 300 includes audio sources 306. The audio sources 306 can be part of an infotainment system of the vehicle. The audio sources 306 can interface with a sound mixer that controls what audio source or sources are currently audible in the vehicle. For example, at any point in time it can be controlled which of the audio sources 306 is currently in focus. The audio sources 306 can include a media player 306A. The media player 306A can be considered a master volume controller in the vehicle (e.g., for overall sound of the vehicle). For example, the media player 306A can control audio from an operating system, from a voice assistant, and from a media library. The audio sources 306 can include a navigation component 306B. For example, the navigation component 306B outputs visual and/or audible instructions for navigating the vehicle. The audio sources 306 can include a short-range wireless (SRW) component 306C. In some implementations, the SRW component 306C can operate using ultra-high frequency radio waves to interface with a portable electronic device of any vehicle occupant. For example, the SRW component 306C can engage in wireless communication according to BLUETOOTH protocol (e.g., to facilitate phone calls.)

The system 300 includes a user interface 308 that can include multiple display devices 310 and multiple physical control devices 312. The display devices 310 can correspond to some or all of the display devices 206, 208, 210, or 212 (FIG. 2). Any or all of the display devices 310 can have touchscreen functionality. The physical control devices 312 can be configured for generating inputs that control various aspects of vehicle operation.

The system 300 includes a container management component 314 for one or more visual representations for presentation on any of the display devices 310. The container management component 314 can use any of multiple container representations 316, such as different versions of any or all of the containers exemplified elsewhere herein. As such, the vehicle can have multiple containers for presentation on the display device 310, and one container can be selected from among the multiple containers for presentation. Such selection can be based on an input made using a hardware control.

The container management component 314 can provide an animation of a container. In some implementations, the animation can include that the container performs a move out onto the display device from an edge of the display device, and/or that a presented container performs a move off of the display device past an edge of the display device. For example, the move can take a predefined time.

FIG. 4 shows examples of hardware controls 400. The hardware controls 400 can be used with one or more other examples described elsewhere herein. The hardware controls 400 can be implemented in the instrument panel 200 (FIG. 2), such as to provide the hardware controls 214, to name just one example.

The hardware controls 400 include hardware controls 400A-400E. Each of the hardware controls 400A-400B and 400D-400E can include a button. In some implementations, the button can be toggled in at least two directions. For example, toggling the button in a first direction (e.g., upward) can increase a setting value, and toggling the button in a second direction (e.g., downward) can decrease a setting value. One or more containers (e.g., the containers 100 and 102 in FIGS. 1A-1B) can mirror or otherwise visually reference the shape of the physical hardware controls.

The hardware controls 400A-400B and 400D-400E can be hardware HVAC controls. In some implementations, the hardware controls 400A-400B can be designated for a left-side passenger in the vehicle. For example, the hardware control 400A can correspond to a temperature setting, and the hardware control 400B can correspond to a fan speed setting. In some implementations, the hardware controls 400D-400E can be designated for a right-side passenger in the vehicle. For example, the hardware control 400D can correspond to a fan speed setting, and the hardware control 400E can correspond to a temperature setting. In some implementations, the hardware control 400C can be a hardware volume control. The hardware control 400C can be a roller control. The volume setting can be applied to one or more audio zones in the vehicle.

FIG. 5 shows an example of a toggle control 500. The toggle control 500 can be used with one or more other examples described elsewhere herein. The toggle control 500 can be implemented in the steering wheel 204 (FIG. 2), such as to provide one or more of the hardware controls 216 or 218, to name just a few examples.

The toggle control 500 can include a moveable component and can be used for generating inputs that control various aspects of vehicle operation. For example, the toggle control can include a rotatable element that can be rotated (e.g., using one's thumb) about an axis that is essentially radial to the circumference of the steering wheel. The toggle control 500 includes a barrel 502 that is rotatably mounted to an axis fixed relative to the steering wheel. The barrel 502 can have cylindrical, conical, or frustoconical shape, to name just a few examples. The barrel 502 can have a structured surface for improved grip and/or tactile experience. Rotation of the barrel in one direction about the axis can generate an input 502A, and rotation of the barrel in an opposite direction about the axis can generate an input 502B, as here schematically shown.

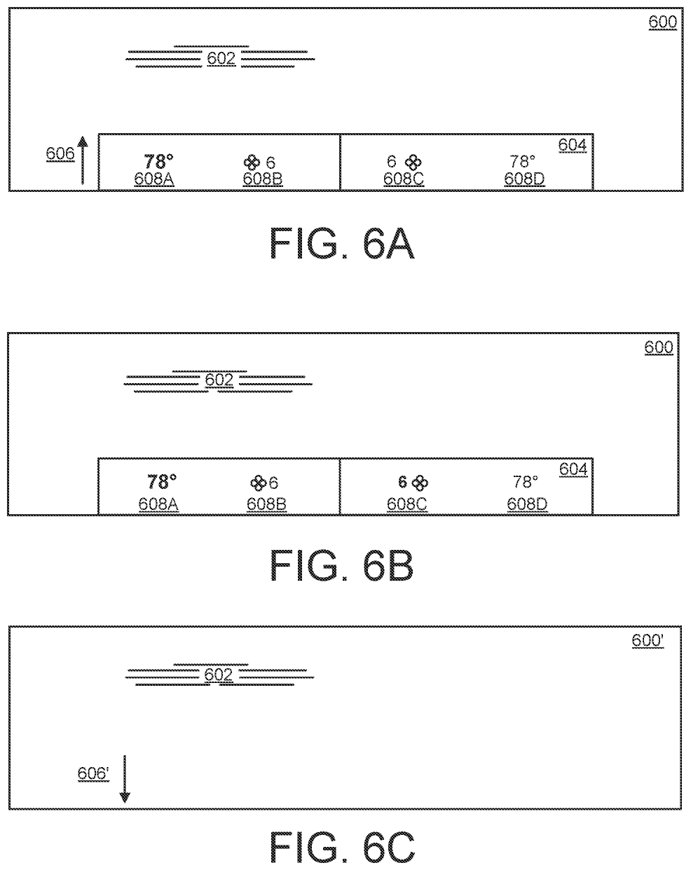

FIGS. 6A-6C show examples of presentations 600 and 600′ on a display device relating to an HVAC control container. Any of the presentations 600 and 600′ can be presented on one or more of the display devices 206, 208, 210, or 212 (FIG. 2). The presentation 600 can include content 602 that is here schematically represented. When a user generates an input by interacting with a hardware control (e.g., any of the hardware controls 400 (FIG. 4) or the toggle control 500 (FIG. 5)), a container 604 can be presented on the display device.

The container 604 can be presented using an animation, as here schematically represented by an arrow 606. A signal from the one of the plurality of hardware controls with which the user interaction occurs can be active during the move. For example, if the user is interacting with a hardware HVAC control to adjust the temperature corresponding to the indication 608A, the temperature value that is set for this zone can be changed (increased or decreased) in according with the user's input, during the time that the animation is moving the container 604 onto the display device. As such, the user need not wait for the animation to finish before the new setting for that vehicle component (e.g., the HVAC system) is applied.

The container 604 can relate to HVAC controls and shows examples of indications 608A-608D. In some implementations, the indications 608A-608B can be designated for a left-side passenger in the vehicle. For example, the indication 608A can correspond to a temperature setting, and the indication 608B can correspond to a fan speed setting. In some implementations, the indications 608C-608D can be designated for a right-side passenger in the vehicle. For example, the indication 608C can correspond to a fan speed setting, and the indication 608D can correspond to a temperature setting. One or more of the indications 608A-608D can be highlighted based on the particular hardware control with which the user is interacting. The indications 608A-608D can show setting values using any applicable unit. For example, temperature can be shown in Fahrenheit or Celsius degrees.

The above examples illustrate that a computer-based method can include: receiving, in a computer system (e.g., the system 300 in FIG. 3) of a vehicle (e.g., the vehicle 202 in FIG. 2), an input generated by user interaction with any of a plurality of hardware controls (e.g., any of the hardware controls 400 (FIG. 4) or the toggle control 500 (FIG. 5)) in the vehicle. The plurality of hardware controls corresponding to respective vehicle systems (e.g., the HVAC system 302 or the audio sources 306 in FIG. 3). The method includes presenting, in response to the input, a container on a display device of the vehicle. The container is configured for displaying indications (e.g., the indications 608A-608D in FIG. 6A) that correspond to and reflect present settings of each of the plurality of hardware controls.

Simultaneous inputs can be generated using two or more hardware controls. In some implementations, an HVAC control container can support simultaneous user interaction using more than one of the multiple hardware HVAC controls. For example, in FIG. 4, the hardware controls 400A and 400D can be interacted with at the same time (e.g., by two different passengers). Those of the multiple HVAC values corresponding to the more than one of the multiple hardware HVAC controls that are being interacted with, can be highlighted. For example, FIG. 6B shows that the indications 608A (e.g., temperature) and 608C (e.g., fan speed) are being highlighted.

The container 604 can cease to be presented upon one or more circumstances, or one or more events occurring or not occurring. Presentation 600′ illustrates that the container 604 has ceased to be presented. In some implementations, the system ceases to present the container 604 in response to a predefined time elapsing after a most recent user interaction with any of the plurality of hardware controls. This can ensure that the container 604 does not remain on the display device when no longer needed. In some implementations, the container 604 can cease to be presented based on user input. For example, the system can cease to present the container 604 in response to a gesture detected by a touchscreen input control. The container 604 can be removed from the presentation 600 using an animation, as here schematically represented by an arrow 606′. For example, the animation can substantially reverse the animation that introduced the container 604 (e.g., with a different time length).

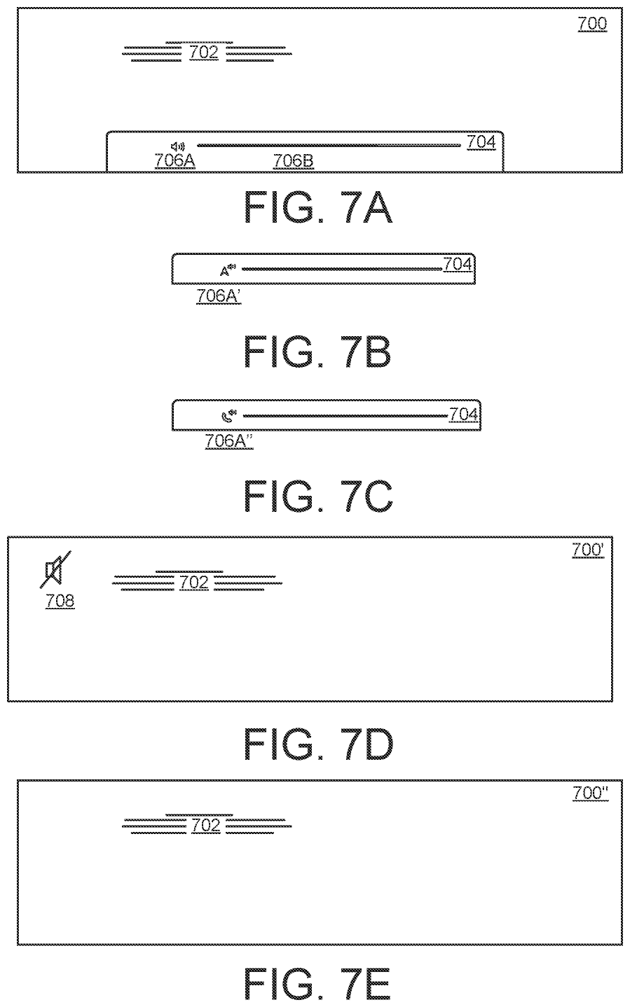

FIGS. 7A-7E show examples of presentations 700, 700′, and 700″ on a display device relating to a volume control container. Any of the presentations 700, 700′, and 700″ can be presented on one or more of the display devices 206, 208, 210, or 212 (FIG. 2). The presentations 700, 700′, and 700″ can include content 702 that is here schematically represented. When a user generates an input by interacting with a hardware control (e.g., any of the hardware controls 400 (FIG. 4) or the toggle control 500 (FIG. 5)), a container 704 can be presented on the display device. The container 704 can be presented using an animation.

The vehicle can include multiple hardware volume controls. Each of such multiple hardware volume controls can be configured for increasing and decreasing volume of audio in the vehicle. For example, each of the hardware control 400C (FIG. 4) and the toggle control 500 (FIG. 5) can be used for controlling volume, and the container 704 can then be presented in response to the user interaction occurring with any of them. The hardware volume control can be configured for controlling whichever one of multiple sound sources in the vehicle that is presently in focus. For example, in FIG. 3, either of the media player 306A, the navigation component 306B, or the short-range wireless component 306C may currently have focus for audio presentation.

The container 704, which relates to volume control, here shows examples of indications 706A-706B. The indication 706A can be an icon representing sound (e.g., a speaker symbol). The indication 706B can be a graphical element representing a volume setting (e.g., a slider). The volume control container can be presented with a respective icon corresponding to a corresponding one of the multiple sound sources that is presently in focus. Here, the indication 706A corresponds to the media player 306A. For example, this can correspond to a master sound source currently having focus. FIG. 7B shows that the container 704 can include an indication 706A′ that corresponds to the navigation component 306B. For example, this can correspond to navigation instructions currently having focus. FIG. 7C shows that the container 704 can include an indication 706A″ that corresponds to the short-range wireless component 306C. For example, this can correspond to a remote sound source (e.g., a phone call on a paired mobile device) currently having focus.

The volume control container can have different numbers of volume control stops for at least some of the multiple sound sources. In some implementations, the indication 706B can correspond to more or fewer individual stops of sound level depending on whether the indication 706A, the indication 706A′, or the indication 706A″, is active. For example, the navigation component 306B and the short-range wireless component 306C can have fewer stops than the media player 306A.

The user can choose any volume setting by interacting with the physical volume control. Lowering the volume as much as possible can correspond to muting the audio system. FIG. 7D shows that the presentation 700′ includes a symbol 708 to indicate the muting. For example, assume that the presentation 700′ is displayed before the above-mentioned input is made using the hardware volume control. Further, assume that the input made corresponds to an increase volume command. For example, the user interacts with either the hardware control 400C (FIG. 4) or the toggle control 500 (FIG. 5) to increase the volume. This can serve to unmute the audio system. For example, the presentation 700 (FIG. 7A) can then be presented, where the symbol 708 is not present, and wherein the container 704 indicates that the volume is unmuted.

The container 704 can cease to be presented upon one or more circumstances, or one or more events occurring or not occurring. In some implementations, the system ceases to present the container 704 in response to a predefined time elapsing after a most recent user interaction with any of the plurality of hardware controls. This can ensure that the container 704 does not remain on the display device when no longer needed. In some implementations, the container 704 can cease to be presented based on user input. For example, the system can cease to present the container 704 in response to a gesture detected by a touchscreen input control. The container 704 can be removed from the presentation 700 using an animation. For example, the animation can substantially reverse an animation that introduced the container 704 (e.g., with a different time length).

Switching between two or more types of container can be performed. In some implementations, this can occur when interaction with a first hardware control causes a first container to be presented, and before the first container vanishes, another interaction with a different hardware control causes a second container to be presented. This can involve a volume control container being seamlessly replaced by a HVAC control container, or vice versa. For example, if the container 604 (FIG. 6A) is currently active, and the user then interacts with a hardware volume control, the container 704 (FIGS. 7A-7C) can instead be activated. For example, this can be done without ceasing to present the container 604 (e.g., contents of the container 704 can replace the contents of the container 604). As another example, this can be done by ceasing to present the container 604, and thereafter presenting the container 704 with the replaced content.

Vehicle systems may be controlled without invoking a container. In some implementations, if the user changes a setting (e.g., volume or HVAC) using a touchscreen control of any of the display devices 310 (FIG. 3), the corresponding container may not be presented. This can avoid cluttering the display device with content that may not be needed.

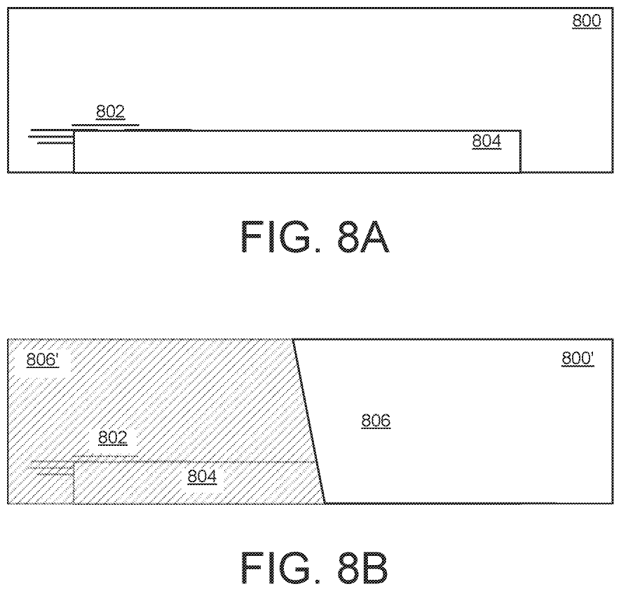

FIGS. 8A-8B show examples of layering of a container. Here, a presentation 800 on a display device presently includes content 802, which is schematically illustrated. The content 802 can include contents of an application executed by the vehicle's computer system, or a status bar, or a menu, to name just a few examples. Upon user interaction with a hardware control, a container 804 can be presented. The container 804 can be presented on top of at least some of the content 802.

Modal content can be presented. FIG. 8B shows that a presentation 800′ includes modal content 806, here schematically shown as positioned in a rightmost portion of the display device. For example, the modal content 806 can correspond to a notification (e.g., an incoming phone call) or an alert. The container 804 can be presented below the modal content 806. The modal content 806 can be associated with scrim 806′. For example, the scrim 806′ can correspond to a shading or other deactivation of other content in the presentation 800′ that is not covered by the modal content 806. The container 804 can be presented below the scrim 806′.

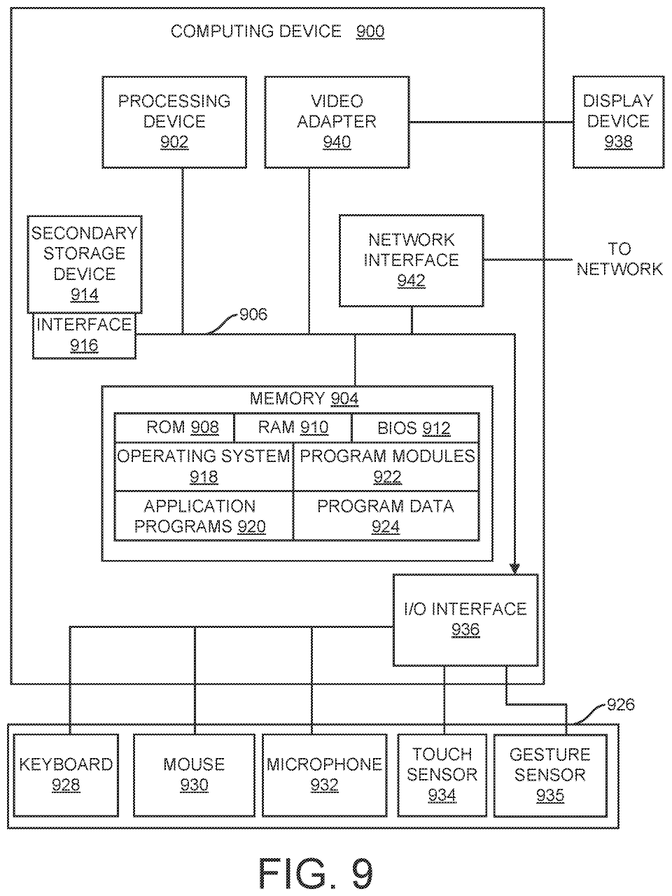

FIG. 9 illustrates an example architecture of a computing device 900 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 9 can be used to execute the operating system, application programs, and/or software modules (including the software engines) described herein.

The computing device 900 includes, in some embodiments, at least one processing device 902 (e.g., a processor), such as a central processing unit (CPU). A variety of processing devices are available from a variety of manufacturers, for example, Intel or Advanced Micro Devices. In this example, the computing device 900 also includes a system memory 904, and a system bus 906 that couples various system components including the system memory 904 to the processing device 902. The system bus 906 is one of any number of types of bus structures that can be used, including, but not limited to, a memory bus, or memory controller; a peripheral bus; and a local bus using any of a variety of bus architectures.

Examples of computing devices that can be implemented using the computing device 900 include a desktop computer, a laptop computer, a tablet computer, a mobile computing device (such as a smart phone, a touchpad mobile digital device, or other mobile devices), or other devices configured to process digital instructions.

The system memory 904 includes read only memory 908 and random access memory 910. A basic input/output system 912 containing the basic routines that act to transfer information within computing device 900, such as during start up, can be stored in the read only memory 908.

The computing device 900 also includes a secondary storage device 914 in some embodiments, such as a hard disk drive, for storing digital data. The secondary storage device 914 is connected to the system bus 906 by a secondary storage interface 916. The secondary storage device 914 and its associated computer readable media provide nonvolatile and non-transitory storage of computer readable instructions (including application programs and program modules), data structures, and other data for the computing device 900.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 914 and/or system memory 904, including an operating system 918, one or more application programs 920, other program modules 922 (such as the software engines described herein), and program data 924. The computing device 900 can utilize any suitable operating system.

In some embodiments, a user provides inputs to the computing device 900 through one or more input devices 926. Examples of input devices 926 include a keyboard 928, mouse 930, microphone 932 (e.g., for voice and/or other audio input), touch sensor 934 (such as a touchpad or touch sensitive display), and gesture sensor 935 (e.g., for gestural input). In some implementations, the input device(s) 926 provide detection based on presence, proximity, and/or motion. Other embodiments include other input devices 926. The input devices can be connected to the processing device 902 through an input/output interface 936 that is coupled to the system bus 906. These input devices 926 can be connected by any number of input/output interfaces, such as a parallel port, serial port, game port, or a universal serial bus. Wireless communication between input devices 926 and the input/output interface 936 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 938, such as a monitor, liquid crystal display device, light-emitting diode display device, projector, or touch sensitive display device, is also connected to the system bus 906 via an interface, such as a video adapter 940. In addition to the display device 938, the computing device 900 can include various other peripheral devices (not shown), such as speakers or a printer.

The computing device 900 can be connected to one or more networks through a network interface 942. The network interface 942 can provide for wired and/or wireless communication. In some implementations, the network interface 942 can include one or more antennas for transmitting and/or receiving wireless signals. When used in a local area networking environment or a wide area networking environment (such as the Internet), the network interface 942 can include an Ethernet interface. Other possible embodiments use other communication devices. For example, some embodiments of the computing device 900 include a modem for communicating across the network.

The computing device 900 can include at least some form of computer readable media. Computer readable media includes any available media that can be accessed by the computing device 900. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 900.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 9 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 900 can be characterized as an ADAS computer. For example, the computing device 900 can include one or more components sometimes used for processing tasks that occur in the field of artificial intelligence (AI). The computing device 900 then includes sufficient proceeding power and necessary support architecture for the demands of ADAS or AI in general. For example, the processing device 902 can include a multicore architecture. As another example, the computing device 900 can include one or more co-processors in addition to, or as part of, the processing device 902. In some implementations, at least one hardware accelerator can be coupled to the system bus 906. For example, a graphics processing unit can be used. In some implementations, the computing device 900 can implement a neural network-specific hardware to handle one or more ADAS tasks.

The terms “substantially” and “about” used throughout this Specification are used to describe and account for small fluctuations, such as due to variations in processing. For example, they can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A computer-based method comprising:
receiving, in a computer system of a vehicle, an input generated by user interaction with any of a plurality of hardware controls in the vehicle, the plurality of hardware controls corresponding to respective vehicle systems; and
presenting, in response to the input, a container on a display device of the vehicle, the container configured for displaying indications that correspond to and reflect present settings of each of the plurality of hardware controls.

2. The computer-based method of claim 1, wherein the vehicle has multiple containers for presentation on the display device, the method further comprising selecting the container from among the multiple containers for presentation, the container selected based on the received input.

3. The computer-based method of claim 2, wherein the container selected from among the multiple containers is a volume control container.

4. The computer-based method of claim 3, wherein the plurality of hardware controls includes multiple hardware volume controls, wherein each of the multiple hardware volume controls is configured for increasing and decreasing volume of audio in the vehicle, and wherein the volume control container is presented in response to the user interaction occurring with any of the multiple hardware volume controls.

5. The computer-based method of claim 4, wherein at least one of the multiple hardware volume controls is a roller control, and wherein at least another one of the multiple hardware volume controls is a toggle control.

6. The computer-based method of claim 4, wherein at least one of the multiple hardware volume controls is positioned on a steering wheel of the vehicle, and wherein at least another one of the multiple hardware volume controls is positioned on an instrument panel of the vehicle.

7. The computer-based method of claim 3, wherein the volume control container is presented in response to user interaction with a hardware volume control, and wherein the hardware volume control is configured for controlling whichever one of multiple sound sources in the vehicle that is presently in focus.

8. The computer-based method of claim 7, wherein the volume control container is presented with a respective icon corresponding to a corresponding one of the multiple sound sources.

9. The computer-based method of claim 7, wherein the volume control container has a different numbers of volume control stops for at least some of the multiple sound sources.

10. The computer-based method of claim 7, wherein the multiple sound sources include at least master audio, navigation audio, and short-range wireless audio.

11. The computer-based method of claim 10, wherein the master audio comprises an overall sound of the vehicle.

12. The computer-based method of claim 10, wherein the navigation audio comprises sound that a navigation component is outputting to a sound mixer of the vehicle.

13. The computer-based method of claim 10, wherein the short-range wireless audio comprises sound that a portable electronic device is outputting to a sound mixer of the vehicle by short-range wireless communication.

14. (canceled)

15. The computer-based method of claim 3, wherein volume is muted in the vehicle before the input is received, wherein the input corresponds to an increase volume command, and wherein the volume control container when presented indicates that the volume is unmuted.

16. (canceled)

17. (canceled)

18. (canceled)

19. (canceled)

20. The computer-based method of claim 2, wherein the container selected from among the multiple containers is a heating, ventilation, and air conditioning (HVAC) control container, wherein the plurality of hardware controls includes multiple hardware HVAC controls, wherein the indications in the HVAC control container include multiple HVAC values corresponding to present settings of the multiple hardware HVAC controls, and wherein the HVAC control container is presented in response to the user interaction occurring with any of the multiple hardware HVAC controls, and wherein a first control of the multiple hardware HVAC controls is dedicated to a left-side passenger of the vehicle, wherein a second control of the multiple hardware HVAC controls is dedicated to a right-side passenger of the vehicle, and wherein the first and second controls are independent of each other.

21. The computer-based method of claim 2, wherein the container selected from among the multiple containers is a heating, ventilation, and air conditioning (HVAC) control container, wherein the plurality of hardware controls includes multiple hardware HVAC controls, wherein the indications in the HVAC control container include multiple HVAC values corresponding to present settings of the multiple hardware HVAC controls, and wherein the HVAC control container is presented in response to the user interaction occurring with any of the multiple hardware HVAC controls, further comprising highlighting in the HVAC control container one of the multiple HVAC values corresponding to the one of the multiple hardware HVAC controls with which the user interaction occurs.

22. The computer-based method of claim 2, wherein the container selected from among the multiple containers is a heating, ventilation, and air conditioning (HVAC) control container, wherein the plurality of hardware controls includes multiple hardware HVAC controls, wherein the indications in the HVAC control container include multiple HVAC values corresponding to present settings of the multiple hardware HVAC controls, and wherein the HVAC control container is presented in response to the user interaction occurring with any of the multiple hardware HVAC controls, and wherein the HVAC control container supports simultaneous user interaction using more than one of the multiple hardware HVAC controls.

23. The computer-based method of claim 22, further comprising highlighting those of the multiple HVAC values corresponding to the more than one of the multiple hardware HVAC controls.

24. (canceled)

25. The computer-based method of claim 2, wherein while the container selected based on the received input is presented, the method further comprises receiving another input generated by another user interaction with another of the plurality of hardware controls, and in response to the other input, replacing content of the container to correspond to the other of the plurality of hardware controls, wherein the content is replaced without ceasing to present the container.

26. The computer-based method of claim 2, wherein while the container selected based on the received input is presented, the method further comprises receiving another input generated by another user interaction with another of the plurality of hardware controls, and in response to the other input, replacing content of the container to correspond to the other of the plurality of hardware controls, wherein replacing the content comprises ceasing to present the container, and thereafter again presenting the container to include the replaced content.

27. (canceled)

28. The computer-based method of claim 1, wherein the display device comprises a touchscreen input control, and wherein the touchscreen input control is configured for controlling a setting of at least one of the vehicle systems, and wherein the container is not presented upon controlling the setting of the vehicle system using the touchscreen input control.

29. The computer-based method of claim 1, wherein the display device comprises a touchscreen input control, further comprising ceasing to present the container in response to a gesture detected by the touchscreen input control.

30. The computer-based method of claim 1, wherein the computer system presents content on the display device, and wherein the container is presented on top of at least some of the content.

31. The computer-based method of claim 30, wherein the content includes modal content, and wherein the container is presented below the modal content.

32. The computer-based method of claim 1, wherein presenting the container comprises presenting an animation wherein the container performs a move out onto the display device from an edge of the display device, and wherein the move takes a predefined time.

33. The computer-based method of claim 32, wherein a signal from the one of the plurality of hardware controls with which the user interaction occurs is active during the move.

34. The computer-based method of claim 1, further comprising ceasing to present the container in response to a predefined time elapsing after a most recent user interaction with any of the plurality of hardware controls.

35. The computer-based method of claim 1, further comprising changing a reading layout of the container.
